(19) United States
(12) Patent Application Publication
(10) Pub. No.: US 2003/0208524 A1
(43) Pub. Date: Nov. 6, 2003

(54) System for routing data in a communication network

(76) Inventors: Daniel N. Morman, Pullman, WA (US); Daniel W. Bodtke, Pullman, WA (US)

Correspondence Address: JENSEN + PUNTIGAM, P.S., SUITE 1020, 2033 6TH AVE, SEATTLE, WA, 98121, US

(21) Appl. No.: 10/139,028

(22) Filed: May 2, 2002

(51) Int. Cl. G06F 15/16

(52) U.S. Cl. 709/201; 709/208

(57) ABSTRACT

The network includes a plurality of data communication devices which are connected in a serial point-to-point arrangement. The protocol used for such communication includes a header portion for each message which is reviewed by a protocol element at the data port of the originating device to identify the proper destination of unsolicited messages. The message is then sent directly to that destination, without being directed through an intermediate device.

### TECHNICAL FIELD

The present invention relates generally to the field of data communication networks, and more specifically concerns the communication of unsolicited data messages in a point-to-point communication network.

### BACKGROUND OF THE INVENTION

Serial point-to-point connection between two data devices is well known. Both solicited and unsolicited messages can be readily communicated within such a system. Solicited messages are those for which one data device (i.e. a “slave”) receives a request for information from another device (the “master”) and transmits a response after first obtaining the requested information. Unsolicited messages refer to those messages which are generated by a slave device and communicated to another device without a request.

Serial point-to-point communication can be used between more than two data devices, although a network with several such serial point-to-point connections soon becomes too complex and unmanageable, since a direct connection is required between each data device, respectively, and every other data device to accomplish complete point-to-point communication capability.

FIG. 1 shows a communications network 10 which includes large numbers of data devices and which has point-to-point communication capability. In this arrangement, a slave device 12 communicates with a point-to-point serial connection to a TCP/IP (transmission control protocol/internet protocol) converter device 14 which is connected to a network 16. A master device 18 also connects to the network 16 via a TCP/IP converter device 20. Direct communication of both solicited and unsolicited messages is possible with such a system. A plurality of slave devices can be connected to the network. The master/slave communication arrangement must be preserved, although different devices on the network can function as master or slave. A particular slave device, however, cannot communicate directly with another slave device with unsolicited messages. In order to accomplish such communication, the master is used as an intermediate connection between the two devices. This does provide one-to-one direct communication, although the inclusion of an intermediate device in every such communication event is expensive.

Accordingly, it would be desirable to have a communication network in which the master/slave arrangement of FIG. 1 could be converted to a network involving a plurality of possible direct point-to-point connections, for both unsolicited and solicited messages, without the necessity of an intermediate processor/controller.

### SUMMARY OF THE INVENTION

Accordingly, the present invention is a system for communicating data in a serial point-to-point manner in a data communications network, which includes a plurality of data communication devices, wherein both solicited and unsolicited data messages are transmitted within the network with a preselected serial point-to-point communication protocol, the system comprising: protocol means located at each data communication device for receiving the identification header of unsolicited messages having said communication protocol which are originated by the data communication devices and determining therefrom the proper destination for said unsolicited messages within the network and transmitting said unsolicited messages over the network directly to said destination.

### BRIEF DESCRIPTION OF THE DRAWINGS

FIG. 1 shows a prior art serial point-to-point network of master/slave communication devices using a TCP/IP connection.

FIG. 2 shows the system of the present invention, involving a point-to-point communication capability within a TCP/IP connection network.

FIG. 3 is the network arrangement of FIG. 2 which includes a number of slave communication devices in the network.

### BEST MODE FOR CARRYING OUT THE INVENTION

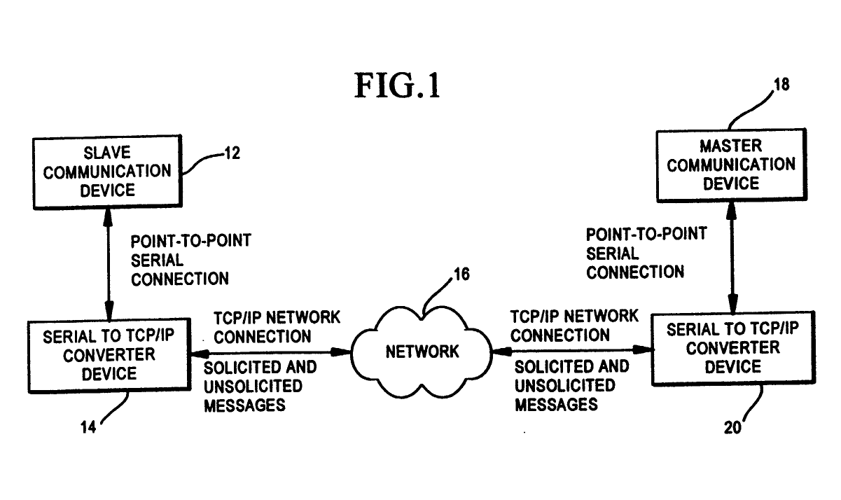

As indicated above, the primary limitation of the prior art data communication system of FIG. 1 is the requirement that all messages from a slave communication device, whether solicited or unsolicited, must be sent through the designated TCP/IP connection of the master device prior to reaching their intended destination in the network. While such a system does have the capability of providing point-to-point connections for solicited and unsolicited messages, the message routing requirement adds expense to the system, as indicated above.

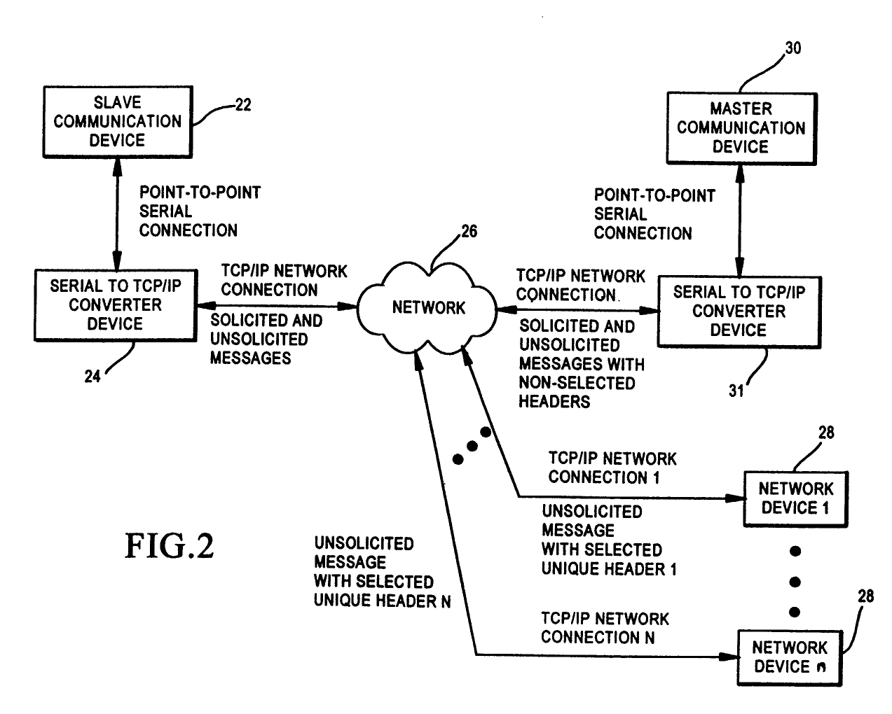

FIG. 2 shows the system of the present invention in which each data communication device in the network includes a protocol communication capability at its data port. This capability includes the ability to read the header information in any message originated by the device, whether solicited or unsolicited, and to determine therefrom the preferred destination of the message. Typically, this destination information will be in the first eight bytes of the header portion of the message. The determination of the destination at the port of the sending device permits the message to be routed directly to the desired destination, i.e. the desired receiving device, without going through the TCP/IP connection of the master device in the network.

In the arrangement of FIG. 2, an unsolicited message from slave communication device 22 can be routed through its TCP/IP converter device 24 and network 26 directly to any one of the selected network devices 28-28. The device or devices which are to receive the messages are referred to as destination devices. Accordingly, point-to-point communication can be achieved within the network for specific unsolicited messages, without the need of proceeding through the connection of the master device. Solicited messages and non-selected (non-specific) unsolicited messages are sent to the TCP/IP connection of the master communication device 30 and TCP/IP converter 31.

At the slave device, the protocol capability essentially is in the form of a plurality of data masks, which are compared with the data pattern in the header of the message. Serial point-to-point protocol, like many other such protocols, has a unique identification header which details the type of protocol and the type of information in the message. A match between a data mask and the header information results in the identification of the address of the destination and the sending or routing of the message directly to the address or addresses of the identified destinations. The identification of the address in the header information is generally routine; and, hence, that function is not further discussed in detail. The important characteristic is that a protocol processor device be located at the data port and that it ultimately identify the destination of the message from the header information of the message itself.

If the header material matches a selectable mask pattern, then the message is routed to a specified address provided by the protocol processor from a table or the like. This system allows the network devices to receive unsolicited messages from other point-to-point devices on the network through a single network connection, rather than through the master connection. As an option, the routed message can have appended thereto the transmitting devices' protocol address to permit archiving of unsolicited messages from various sources.

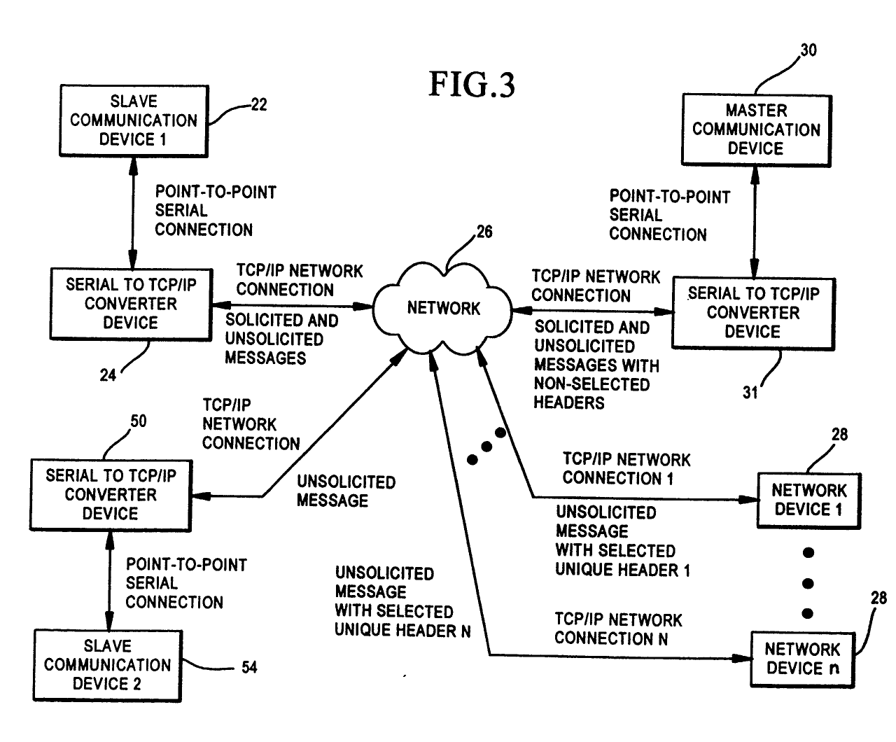

FIG. 3 shows a modification of FIG. 2 involving more than one slave communication device 50 and associated serial-to-TCP/IP converter device 54.

Many unsolicited message protocols require an acknowledgment from the destination device to prevent retransmission of the original message by the sending device. The serial to TCP/IP converter 24 in the present system (FIG. 3) uses a selectable flag to determine whether or not an acknowledgement of an unsolicited message is expected. If the flag is set, then the TCP/IP connection at the sending device remains open to await the acknowledgment from the receiving device. Otherwise, the TCP/IP connection at the sending device is closed. A TCP/IP connection at the sending device to the network 16 is opened for each unsolicited message from the sending device. The connection remains open until an acknowledgment is received or the message has otherwise been successfully transmitted.

In operation, a particular data device in the network will generate information which is to be sent unsolicited to one or more other devices in the network. As an example, the network could comprise a plurality of protective relays used to monitor the operation of an electric power system. Any relay in that network could, in its operation, produce information which is useful in the protection arrangement, to one or more other relays in the system. Once the message (the generated information) is formulated, a header is added which includes destination information. The protocol at the data port of the sending device identifies the destination information through its mask capability and then routes the information to the identified destination. Information which has been solicited from a particular device by the master device is sent directly back to the master through its TCP/IP connection.

The above arrangement is convenient, not only for increasing the capability of the point-to-point network while reducing expense, but also for changing the protocol capability to add or subtract devices from the network, or changing other aspects of the communication capability. Hence, the present invention adds significantly to the operational flexibility of a data communications network, with respect to the communication of unsolicited messages.

Although a preferred embodiment of the invention has been disclosed here for purposes of illustration, it should be understood that various changes, modifications and substitutions may be incorporated without departing from the spirit of the invention, which is defined by the claims which follow. What is claimed is:

1. A system for communicating data in a serial point-to-point manner in a data communications network, which includes a plurality of data communication devices, wherein both solicited and unsolicited data messages are transmitted within the network with a pre-selected serial point-to-point communication protocol, the system comprising:
protocol means located at each data communication device for reviewing an identification header of unsolicited messages having said communication protocol which are originated by the data communication devices and determining therefrom the proper destination for said unsolicited messages within the network and transmitting said unsolicited messages over the network directly to said destination.

2. A system of claim 1, wherein said destination is another data communication device.

3. A system of claim 1, wherein the network includes a plurality of slave data communication devices and a master communication device, each having an associated protocol means, wherein the master communication device can select information from any of the slave communication devices.

4. A system of claim 1, wherein said protocol means can be conveniently modified to accommodate changes in the network.

5. A system of claim 1, wherein the protocol means includes a series of masks which are compared with the protocol header information in the message originated by the data communication device to determine the destination of said message.

6. A system of claim 1, wherein the destination is determined by review of the first eight bytes of the protocol header portion of the message.
